(19) United States
(12) Patent Application Publication
(10) Pub. No.: US 2014/0113129 A1
(43) Pub. Date: Apr. 24, 2014

(54) MULTI-LAYERED STRUCTURE OF ALTERNATING CONDUCTING AND NON-CONDUCTING LAYERS

(71) Applicant: Heraeus Precious Metals GmbH & Co. KG, Hanau (DE)

(72) Inventors: Murad Abu Asal, Hanau (DE); Oliver Keitel, Aschaffenburg (DE); Stefan Schibli, Frankfurt am Main (DE); Andreas Reisinger, Alzenau (DE)

(73) Assignee: Heraeus Precious Metals GmbH & Co. KG, Hanau (DE)

(21) Appl. No.: 14/056,450

(22) Filed: Oct. 17, 2013

Related U.S. Application Data
(60) Provisional application No. 61/717,269, filed on Oct. 23, 2012.

(30) Foreign Application Priority Data
Oct. 23, 2012 (DE) 102012020734.4
Apr. 29, 2013 (DE) 102013207779.3

(51) Int. Cl. H01B 13/06; G01N 27/00

(52) U.S. Cl. CPC H01B 13/06; G01N 27/00
USPC 428/336; 427/58; 427/126.3; 427/126.4; 428/472

(57) ABSTRACT

One aspect relates to a method for producing a layered structure, comprising at least the following steps: Providing a substrate, applying a first liquid onto at least part of the substrate, drying the first liquid forming a first layer, applying a second liquid onto at least part of the first layer, drying the second liquid forming a second layer, whereby either the substrate and the second layer are electrically conductive and the first layer is insulating or whereby the substrate and the second layer are insulating and the first layer is electrically conductive. One aspect relates to a layered structure that can be obtained according to the method specified above.

### CROSS-REFERENCE TO RELATED APPLICATIONS

This Non-Provisional Patent Application claims the benefit of the filing date of U.S. Provisional Patent Application Ser. No. 61/717,269 filed Oct. 23, 2012, entitled “MULTI-LAYERED STRUCTURE OF ALTERNATING CONDUCTING AND NON-CONDUCTING LAYERS,” and this Patent Application also claims priority to German Patent Application No. DE 10 2012 020 734.4, filed on Oct. 23, 2012 and DE 10 2013 207 779.3, filed on Apr. 29, 2013, all of which are incorporated herein by reference.

### BACKGROUND

One aspect relates to a method for producing a layered structure. Prior methods describe layered structures having layers differing in conductivity which are usually produced through the use of laborious sputtering processes. This involves the use of complex equipment for maintenance of the process conditions and, in addition, expensive methods for vaporization of the materials used for sputtering. In general, it is desired to overcome, at least in part, the disadvantages resulting according to the prior art.

For these and other reasons there is a need for the present invention.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts. FIG. 1 illustrrates a schematic structure of a layered structure according to one embodiment with a substrate.

FIG. 2 illustrates a schematic depiction of the application of a first liquid onto a substrate in order to form a first layer.

FIG. 3 illustrates a schematic depiction of the application of a second liquid onto the first layer of the substrate from FIG. 2 in order to form a second layer.

FIG. 4 illustrates a schematic depiction of a production method for a layered structure comprising a substrate, a first layer, a second layer, a further first layer and a further second layer; produced through repeating the steps according to FIG. 2 and FIG. 3.

FIG. 5 illustrates a measuring device comprising a layered structure.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

One embodiment relates to a method for producing a layered structure, comprising at least the following steps: providing a substrate, applying a first liquid onto at least part of the substrate, drying the first liquid forming a first layer, applying a second liquid onto at least part of the first layer, drying the second liquid forming a second layer, whereby either the substrate and the second layer are electrically conductive and the first layer is insulating or whereby the substrate and the second layer are insulating and the first layer is electrically conductive.

Moreover, one embodiment relates to a layered structure that can be obtained according to the method specified above as well as a layered structure containing at least three layers: (i) a substrate, (ii) a first layer, (iii) a second layer, whereby either the substrate and the second layer are electrically conductive and the first layer is insulating or whereby the substrate and the second layer are insulating and the first layer is electrically conductive. Furthermore, one embodiment relates to a measuring device containing the layered structure described above.

One embodiment provides an inexpensive and efficient method for producing a layered structure of at least three layers. One embodiment provides a method for producing a layered structure of at least three layers that can be used to produce layers that are as thin as possible.

One embodiment provides a simple and rapid method for producing a layered structure of at least three layers of which at least two layers differ in conductivity, that is, of which at least one layer is electrically conductive and at least one second layer is insulating.

One embodiment provides a method for producing a layered structure of at least three layers that is associated with as little waste as possible, in particular in as far as it concerns waste that is expensive to dispose of

One embodiment provides a layered structure of at least three layers that is simple and inexpensive to produce.

One embodiment provides a measuring device having a layered structure that is as simple and inexpensive to produce as possible. One embodiment provides a measuring device having a layered structure, whereby the layered structure is at least as accurate, reliable or long-lasting in use as the measuring devices with layered structures known according to the prior art.

One embodiment is a method for producing a layered structure, comprising the steps:
a. providing a substrate;
b. applying a first liquid onto at least part of the substrate;
c. drying the first liquid forming a first layer;
d. applying a second liquid onto at least part of the first layer;
e. drying the second liquid forming a second layer;

whereby
A) the substrate and the second layer are electrically conductive and the first layer is insulating or
B) the substrate and the second layer are insulating and the first layer is electrically conductive.

In the scope of one embodiment, “electrically conductive” shall be understood to mean that the object referred to as being electrically conductive has a specific sheet resistance of less than 10 kΩ (10,000 Ohm), in one embodiment less than 5 kΩ or in one embodiment less than 1 kΩ In many cases, the specific sheet resistance is concurrently more than 1 Ω, in one embodiment more than 5 Ω, though. If the substrate includes multiple electrically conductive layers, the specific sheet resistance of each of said layers meets at least one of the preceding criteria. Several of the multiple electrically conductive layers can have the same or different sheet resistance values within the range of the criteria specified above.

In the scope of one embodiment, “insulating” shall be understood to mean that the object referred to as being insulating has a specific sheet resistance of more than 50 kΩ, in one embodiment more than 500 kΩ or in one embodiment more than 1 MΩ (1,000,000 Ohm). In many cases, the specific sheet resistance is concurrently less than 100 MΩ, in one embodiment less than 10 MΩ, though. If the substrate includes multiple electrically conductive layers, the specific sheet resistance of each of said layers meets at least one of the preceding criteria. Several of the multiple electrically conductive layers can have the same or different sheet resistance values within the range of the criteria specified above.

“Biocompatible” shall be understood to mean that the object referred to as being biocompatible meets the pertinent biocompatibility requirements according to the ISO 10993 1-20 standard.

As a matter of principle, the formation of a layer according to the method according to one embodiment can proceed according to any method known to, and deemed to be well-suited for the method according to in one embodiment by, a person skilled in the art. In one embodiment, one, several or all layer(s) are formed by a sol-gel method or any method in which a layer is formed by means of depositing particles from a colloidal solution or a dispersion. In the scope of one embodiment, the sol-gel method is used for the production of insulating layers. Application by means of deposition from colloidal solution or from dispersion is used for the production of electrically conductive layers in one embodiment. The preceding methods are known to a person skilled in the art.

In a method according to one embodiment, the application is carried out by means of contacting to a liquid, for example, by means of immersing into the liquid or by means of spraying the liquid onto the substrate that may be coated. Multiple layers can be applied in identical or different manner. Even multiple equal layers can be applied in different manner, that is, for example by means of immersing on one case and by means of spraying in another case.

A substrate that can be used in the method according to one embodiment usually includes more than one surface. The substrate can have any geometrical shape that is known to, and deemed to be suitable for use in the method according to one embodiment by a person skilled in the art, for example, a planar or arced surface such as, for example, a planar or arced plate, a planar or arced disc or a straight or curved tube. In one method according to one embodiment, the substrate is coated according to the specified method on at least one surface of the substrate or on multiple surfaces, or on all surfaces, of the substrate. Different surfaces of the substrate can be provided with different or identical layered structures. In one embodiment, all surfaces of the substrate are simultaneously subjected to the method according to one embodiment in a single step. In this case, all surfaces treated according to the method have the same layered structure. The method according one embodiment is carried out in discontinuous manner as an immersion procedure. The method according to one embodiment can just as well be carried out continuously as a continuous system. In this case, according to one embodiment, the substrate can be guided as a flat ribbon or a tube from a dispensing roller through an immersion bath containing a first liquid, a furnace, an immersion bath containing a second liquid, and a furnace onto a receiving roller.

In a method according to one embodiment, parts of the substrate are covered with a masking agent, for example a lacquer, for example, a plating resist or so-called photo-resist, prior to applying the liquid and the covering means is removed after forming the layer by drying, and a layer with gaps in which no layer has been applied is thus formed. In one embodiment, a further layer is then applied, whereby the gaps provide for a direct contact to exist between substrate and the further layer.

In a method according to one embodiment, parts of a layer of a substrate that is coated at least with said layer are covered with a masking agent, for example a lacquer, for example, a plating resist or so-called photo-resist, prior to applying the liquid for forming a further layer and the covering means is removed after forming the further layer by drying, and a further layer with gaps in which no further layer has been applied is thus formed. In one embodiment, yet a further layer is then applied, whereby the gaps in the further layer provide for a direct contact to exist between the one layer and the further layer.

A photoresist is a masking means that is resistant to the chemicals used in the method according to one embodiment at least for a certain period of time, and in one case, permanently. A photoresist precursor is initially applied to the full surface of a substrate and a lacquer is formed. Then, parts of the substrate are exposed to radiation. The applied lacquer is then destroyed at the exposed sites by the irradiation and any residues of the destroyed lacquer are removed. The substrate treated according to the preceding alternative method is then subjected to the method according to one embodiment.

In a second alternative method, a photoresist precursor is being applied. However, the lacquer is formed only at the sites that are exposed to radiation. Any non-fixed and/or non-cured photoresist precursor is then removed. The substrate treated according to the preceding alternative method is then subjected to the method according to one embodiment.

In a method according to one embodiment, steps b. to e. are repeated at least once.

In a method according to one embodiment, the ratio of the surface areas of second layer to first layer is less than one. In one embodiment, the ratio of the surface areas of each layer to each preceding layer is less than one.

In a the method according to one embodiment, the at least one insulating layer includes at least one compound selected from the group consisting of TiO₂, SiO₂, Ta₂O₅, ZrO₂, Al₂O₃ or a mixture of at least two of these. In a method according to one embodiment, the liquid for producing an insulating layer includes at least one compound selected from the group consisting of TiO₂, SiO₂, Ta₂O₅, ZrO₂, Al₂O₃ or a mixture of at least two of these.

According a method according to one embodiment, the liquid for producing an insulating layer includes at least one precursor compound selected from the group consisting of titanium alkoxylate, silicon alkoxylate, tantalum alkoxylate, zirconium alkoxylate, aluminium alkoxylate or a mixture of at least two of these. Tetramethylorthosilicate, tetraethylorthosilicate, tetra-(n-propyl)orthosilicate, tetraisopropylorthosilicate, tetra-(n-butyl)orthosilicate, tetra-(isobutyl)orthosilicate, tetramethylorthotitanate, tetraethylorthotitanate, tetra-(n-propyl)orthotitanate, tetraisopropylorthotitanate, tetra-(n-butyl)orthotitanate, tetraisobutylorthotitanate, tantalum pentamethanolate, tantalum pentaethanolate, tantalum penta-(n)-propanolate, tantalum penta-(i)-propanolate, tantalum pentabutanolate, tantalum penta-(i)-butanolate, zirconium tetramethanolate, zirconium tetraethanolate, zirconium tetra-(n)-propanolate, zirconium tetra-(i)-propanolate, zirconium tetra-(n)-butanolate, zirconium tetra-(i)-butanolate, aluminium-(n-propanolate), aluminium-(i-propanolate), aluminium-(n-butanolate) or aluminium-(i-butanolate) are preferred in one embodiment. In one embodiment, an alcohol is selected as solvent, and in one embodiment the alcohol corresponds to the alcoholate. When this liquid is being dried, the metal oxide corresponding to the metal cation is formed from the precursor compound.

In a method according to one embodiment, the substrate is selected from the group consisting of glass, TiO₂, SiO₂, Ti₂O₃, Ta₂O₅, ZrO₂, stainless steel, for example, if well-suited for medical implants, such as, for example, 316L and 304, CoCr alloys, a NiCoCRMo alloy, Pt, Au, Ag, W, Ir, Ti, Nb, Ta, NiTi alloys or a mixture of at least two of these.

In a method according to one embodiment, the at least one electrically conductive includes at least one compound selected from the group consisting of indium-tin oxide, antimony-tin oxide, aluminum-zinc oxide, a metal and a metal alloy, stainless steel, for example, if well-suited for medical implants, such as, for example, 316L and 304, CoCr alloys, a NiCoCRMo alloy such as, for example, MP35N, Pt, Au, Ag, W, Ir, Ti, Nb, Ta, NiTi alloy or a mixture of at least two of these.

In a method according to one embodiment, the liquid for producing an electrically conductive layer includes a plurality of particles of at least one compound selected from the group consisting of indium-tin oxide, antimony-tin oxide, aluminum-zinc oxide, a metal and a metal alloy, stainless steel, for example, if well-suited for medical implants, such as, for example, 316L and 304, CoCr alloys, a NiCoCRMo alloy such as, for example, MP35N, Pt, Au, Ag, W, Ir, Ti, Nb, Ta, NiTi alloy or a mixture of at least two of these.

The particle sizes of indium-tin oxide (called ITO in the following), aluminum-zinc oxide, and antimony-tin oxide (called ATO in the following) are in one embodiment less than 50 μm, and in one embodiment less than 30 μm. The particle size of metals is in various embodiments in a range of less than 1,000 nm, less than 100 nm, and less than 10 nm. Often, the particle size of metals concurrently is more than 2 nm, though. Said particle sizes can be determined using a scanning electron microscope.

In a method according to one embodiment, the drying of the first liquid or second liquid or both liquids is carried out, in each case, at a temperature in a range from 50 to 500° C., in one embodiment in a range from 80 to 300° C. or in one embodiment in a range from 100 to 400° C. or in a range from 100 to 200° C. The drying is in one embodiment carried out for a period of time in a range from 1 to 300 minutes, in one embodiment in a range from 2 to 240 minutes, and in one embodiment in a range from 5 to 60 minutes or from 60 to 120 minutes, each at atmospheric pressure (=1 bar) on air or in a protective gas atmosphere. In one embodiment, drying is carried out under reducing conditions. In this case, air or protective gas and, in addition, for example hydrogen, are supplied into the gas space of the furnace. According to one embodiment, the drying of the first liquid or second liquid or both liquids is carried out, in each case, at a temperature in a range from 100 to 400° C. for a period of time in a range from 60 to 120 minutes at atmospheric pressure.

In one embodiment, a layered structure can be obtained according to the method described above.

A layered structure comprising at least three layers includes the layers in the following order:
i. a substrate;
ii. a first layer;
iii. a second layer;

whereby either
A) the substrate and the second layer are electrically conductive and the first layer is insulating or
B) the substrate and the second layer are insulating and the first layer is electrically conductive.

Said layered structure can be produced according to a method according to one embodiment as described above or according to the refinements thereof.

In a layered structure according to one embodiment, the layered structure includes further layers, whereby each further first layer is adjacent to at least one second layer.

In a layered structure according to one embodiment, the substrate has a specific sheet resistance of less than 10 kΩ or, in one embodiment, of less than 5 kΩ, and in one embodiment of less than 1 kΩ. In many cases, the specific sheet resistance of the substrate is more than 1 Ω or more than 5 Ω, though. According to one embodiment, the specific sheet resistance of the substrate is in a range from 1 Ω to 10 kΩ The sheet resistance is measured using a 4-contact measuring procedure and the Nagy SD-600 measuring unit fitted with SDKR-25 and SDKR-13 measuring contacts (available from NAGY Messsysteme GmbH, Siedlerstr. 34, 71126 Gäufelden, Germany).

In a layered structure according to one embodiment, the thickness of one or several, or of all, layers of the layered structure according to one embodiment after drying is in a range from 0.05 μm to 10 μm, in one embodiment from 0.25 μm to 2.5 μm or in one embodiment 0.5 μm to 2 μm. The thickness of a layer can be measured through producing a transverse section of the layered structure and measuring the thickness of the layers on the transverse section in a scanning electron microscope, perpendicular to the substrate surface and the layered structure.

In a layered structure according to one embodiment, the substrate and at least one, or several or all of the layers that contact the body or body fluids directly are biocompatible.

FIG. 1 illustrates a layered structure 1 comprising an electrically conductive substrate 2 according to one embodiment. A first insulating layer 4 is situated thereon. A second electrically conductive layer 6 is situated on said first insulating layer 4. Said second electrically conductive layer 6 has a further insulating layer 4′ situated on it that was produced and is designed just like the first insulating layer 4. Moreover, the further insulating layer 4′ has a further electrically conductive layer 6′ situated on it that was produced and is designed just like the second electrically conductive layer 6. The materials of the electrically conductive (6, 6′, 6″) and of the insulating (4, 4′, 4″) layers are all biocompatible. They all can be used as an external coating for a sensor or a measuring device 30 for use in a live or dead human or animal body.

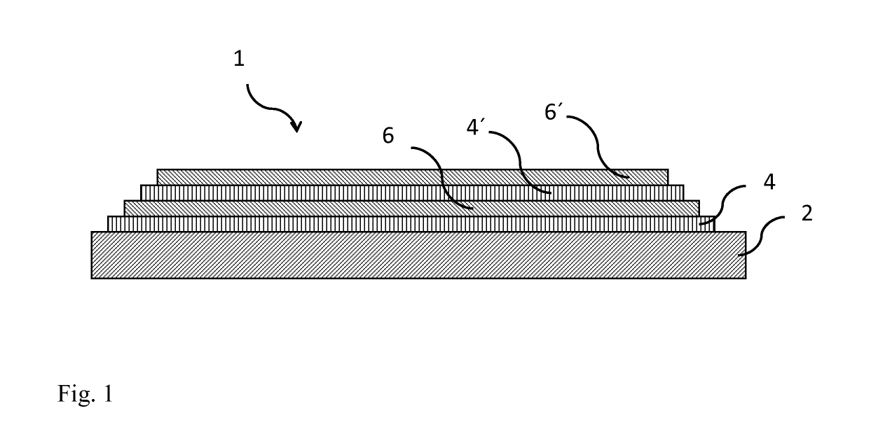

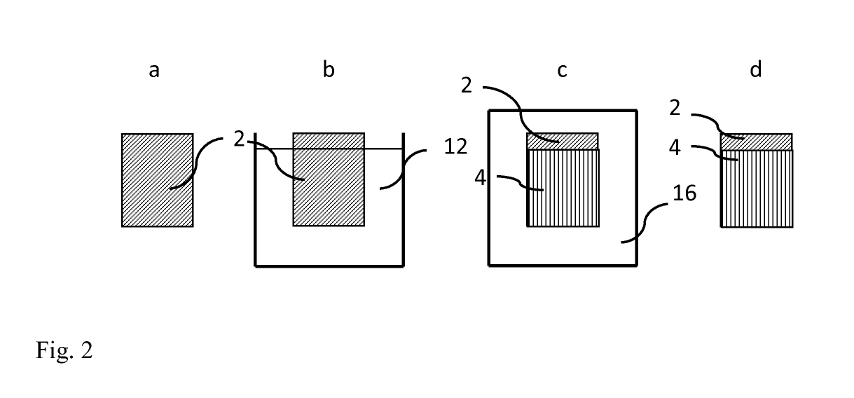

FIG. 2 illustrates part of the steps for a process for producing a layered structure 1. A substrate 1 is provided in a first step a. In a second step b, the substrate is immersed partly in a first liquid 12 in an immersion bath 22 in order to produce an insulating layer. The immersion rate is 2 mm/s , the immersion time is 10 s, and the drawing rate is 7 mm/sec. Subsequently, the excess of liquid is allowed to drip off for 10 seconds and dried, together with the first liquid 12 that has not dripped off, in a furnace 16 at 200° C. for 1 hour in a step c. A first layer 4 is formed in the process, as illustrated in FIG. 2d.

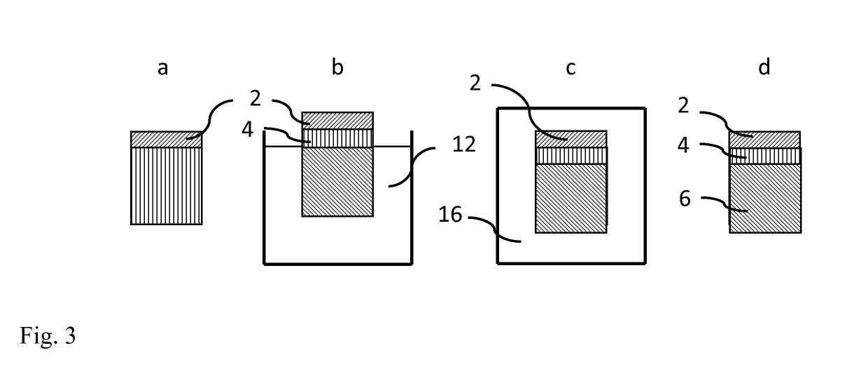

FIG. 3 illustrates the application of a second layer 6 according to one embodiment. For this purpose, the substrate that was produced earlier and is coated with the first layer 4 in FIG. 2 is provided in a step a. In a step b, the coated substrate is immersed partly in a second liquid 14 in order to produce a conductive layer. The immersion rate in this context in one embodiment is 2 mm/s, the immersion time is 10 s, and the drawing rate is 7 mm/sec. Subsequently, the excess of liquid is allowed to drip off for 10 seconds. The substrate 2 is then dried, together with the first layer 4 and the liquid 14 that has not dripped off, in a furnace at 200° C. for 1 hour in step c. A layer 6 is formed in the process, as illustrated in FIG. 3d.

The steps described in FIGS. 2 and 3 can be repeated once or multiple times (not illustrated).

Alternatively, in one embodiment an insulating substrate can be used. In this case, a liquid for producing an electrically conductive layer is used as first liquid and a liquid for producing an insulating layer is used as second liquid.

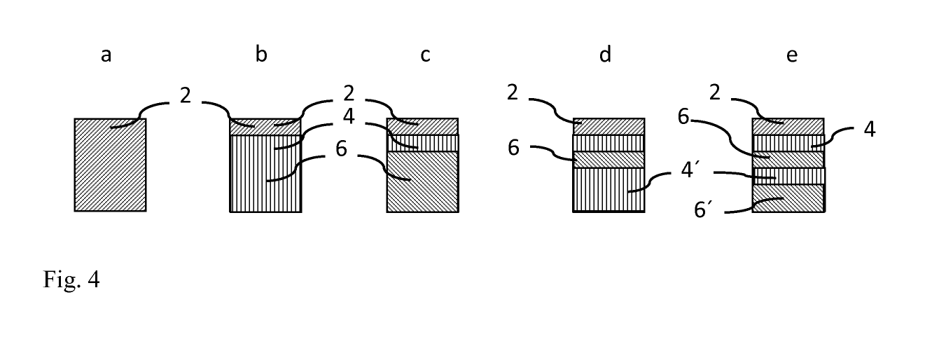

FIG. 4 illustrates a substrate 2 with a partial coating made of a first layer 4, which, in turn, is partially coated with a second layer 6, which, in turn, is partially coated with a further first layer 4′, which, in turn, is partially coated with a further second layer 6′. If the substrate 2, and further second layers, if applicable, is/are made of an insulating material, the first layer, as well as the further first layers 4′ and 4″, etc., are made of an electrically conductive material. However, if the substrate 2, and the second layer and further second layers, if applicable, are made of an electrically conductive material, the first layer, as well as the further first layers 4′ and 4″, etc., are made of an insulating material.

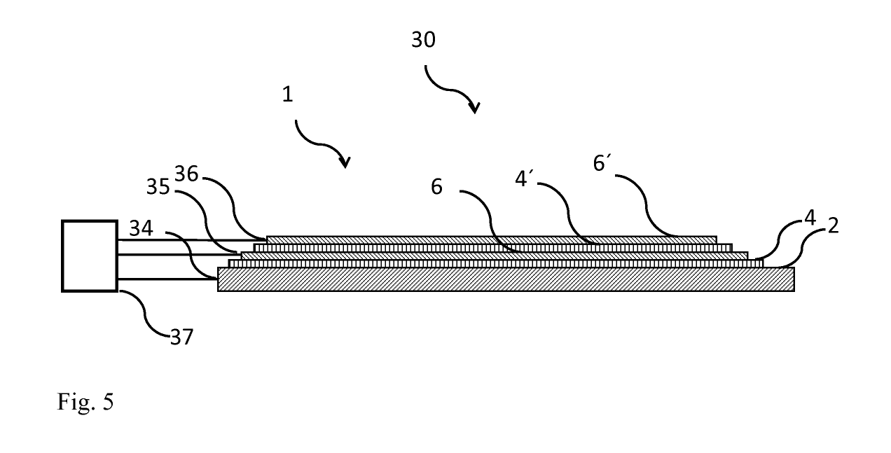

FIG. 5 illustrates a measuring device 30 having a layered structure 1 (as in FIG. 1). The layered structure 1 includes a substrate 2 and, in alternating order, two first layers 4, 4′ and two second layers 6, 6′. The substrate 2 and the layers 6, 6′ of the layered structure 1 are connected through contacts 34, 35, and 36 to an analytical unit 37.

The measuring device 30 is, for example, a sensor having an analytical unit 37 that measures a current flow or a change of the electrical potential between the contacted layers 6, 6′ and the substrate 2. The sensor 30 is made to contact an analyte (not shown). Contacting to the analyte changes the electrical properties of the layered structure 1. This is detected and displayed by the analytical unit 37,

One embodiment shall be illustrated in more detail in the following based on one example that does not limit its scope.

### EXAMPLE

Step 1:

A tube with a length of 100 mm and an external diameter of 1 mm made of 316L grade steel is masked on both sides using shrinkable tubing (polyimide, available from Detakta Isolier-und Messtechnik GmbH & Co KG, Norderstedt, Germany). The length of tube that is not covered is 94 mm. The masked substrate is immersed at an immersion rate of 2 mm/s in a hydrolysed tetraisopropylorthotitanate sol-gel bath (containing: 15% by weight tetraisopropyltitanate, 1.5% by weight doubly distilled water, 6% by weight 0.1N hydrochloric acid, i-propanol adding up to a total of 100% by weight) and pulled out after 10 s at a drawing rate of 7 mm/s. Subsequently, the excess liquid is allowed to drip off for 20 s. Then the film remaining on the substrate is cured in a furnace (Nabertherm HAT 08/17) at a pressure of 1 bar for 1 hour at 200° to form a layer of TiO₂. The layer has a thickness of 200 nm and a specific sheet resistance of ≧200 kΩ (200 kΩ is the maximal value displayed by the Nagy SD-600 measuring device used here). Subsequently, the masking is stripped off.

Step 2:

The TiO₂-coated tube from step 1 is then masked again on both sides with shrinkable tubing (see above). The length that is not covered is 88 mm in this case. The thus masked tube, which is coated with a layer, is then immersed at an immersion rate of 2 mm/s in an ITO suspension (containing: 20% by weight ITO powder (VPITO TC8 available from Evonik Industries AG, Essen, Germany), 73% by weight ethanol, 7% by weight hydrolysed 3-methacryloxypropyltrimethoxysilane), pulled out at a drawing rate of 6 mm/s, and the liquid is allowed to drip off for 20 s. Subsequently, the film remaining on the coated substrate is cured in a furnace at a pressure of 1 bar for 1 hour at 200° C. in the presence of forming gas. The layer has a thickness of 600 nm and a specific sheet resistance of 1,000 Ω. Subsequently, the masking is stripped off as before.

Steps 3 and 4:

The tube from step 3 thus obtained, which is coated with one layer of TiO₂ and ITO each, is used to repeat steps 1 (length not covered of 82 mm) and 2 (length not covered of 76 mm). As a result, a tube coated with layers in the following order is obtained: tube-TiO₂-ITO-TiO₂-ITO.

Measuring the specific sheet resistance

The sheet resistance is measured with a Nagy SD-600 equipped with an

SDKR-25 measuring contact by placing the measuring contact on the layer to be tested. The unit is calibrated using a Nagy E-500 calibration box (calibrating points 0 and 10 Ω) before the actual measurement. If the layer of the layered structure to be tested is not planar, a reference sample is produced. For this purpose, a substrate sized 3 cm×3 cm is subjected to the same production method as the layer of the layered structure to be tested. The material of the substrate of the reference sample is selected to be the same as the material of the substrate of the layered structure.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof

What is claimed is:

1. A method for producing a layered structure comprising:
providing a substrate;
applying a first liquid onto at least part of the substrate;
drying the first liquid forming a first layer;
applying a second liquid onto at least part of the first layer;
drying the second liquid forming a second layer;
wherein the substrate and the second layer are electrically conductive and the first layer is insulating or the substrate and the second layer are insulating and the first layer is electrically conductive.

2. The method according to claim 1, wherein steps applying a first liquid, drying the first liquid, applying a second liquid and drying the second liquid are repeated at least once.

3. The method according to claim 1, wherein the ratio of the surface areas of second layer to first layer is less than one.

4. The method according to claim 1, wherein the at least one insulating layer comprises at least one compound selected from a group consisting of TiO₂, SiO₂, TiO₂, SiO₂, Ta₂O₅, ZrO₂, Al₂O₃ or a mixture of at least two of these.

5. The method according to claim 1, wherein the at least one electrically conductive layer comprises at least one compound selected from the group consisting of indium-tin oxide, antimony-tin oxide, aluminum-zinc oxide, a metal and a metal alloy or a mixture of at least two of these.

6. The method according to claim 1, wherein the substrate is selected from a group consisting of glass, TiO₂, SiO₂, Ti₂O₃, Ta₂O₅, ZrO₂, a steel, a CoCr alloy, a NiCoCrMo alloy, Pt, Au, Ag, W, Ir, Ti, Nb, Ta, a NiTi alloy or a mixture of at least two of these.

7. The method according to claim 1, wherein the drying of the first liquid or second liquid or both liquids is carried out, in each case, at a temperature from 50 to 500° C.

8. A layered structure comprising at least three layers, whereby the layered structure comprises the layers in the following order:
a substrate;
a first layer; and
a second layer;
wherein the substrate and the second layer are electrically conductive and the first layer is insulating or the substrate and the second layer are insulating and the first layer is electrically conductive.

9. The layered structure according to claim 8 comprising further layers, whereby each further first layer is adjacent to at least one further layer.

10. The layered structure according to claim 8, wherein the substrate has a sheet resistance of less than 10 kΩ.

11. The layered structure according to claim 8, wherein the thickness of at least one of the layers after drying is in a range from 0.05 to 10 μm.

12. The layered structure according to claim 8, wherein the substrate is selected from a group consisting of glass, TiO₂, SiO₂, Ti₂O₃, Ta₂O₅, ZrO₂, a steel, CoCr, a NiCoCrMo alloy, Pt, Au, Ag, W, Ir, Ti, Nb, Ta, NiTi or a mixture of at least two of these.

13. The layered structure according to claim 8, wherein the substrate and at least one of the layers are biocompatible.

14. The layered structure according to claim 8 configured as a measuring device.
